(19) United States
(12) Patent Application Publication
(10) Pub. No.: US 2008/0135542 A1
(43) Pub. Date: Jun. 12, 2008

(54) Ceramic Heater and Methods of Manufacturing Same

(76) Inventor: Fermin Adames Sr., Wood Dale, IL (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 11/573,927

(22) PCT Filed: Aug. 17, 2005
(86) PCT No.: PCT/US05/29741

§ 371 Date: Sep. 4, 2007

Related U.S. Application Data
(60) Provisional application No. 60/602,204, filed on Aug. 17, 2004.

(51) Int. Cl. H05B 3/48; H05B 3/10; B29C 70/68

(52) U.S. Cl. 219/520; 219/553; 219/544; 219/539; 264/259

(57) ABSTRACT

Heaters and methods of manufacturing ceramic heaters are provided. The heater includes a ceramic cylindrical-shaped body and an electrical connector connected at one end of the body. The electrical connector may be a screw-in connector. The heater also includes one or more resistance coils, filaments, wires or the like, that are embedded in the ceramic body and are electrically coupled to the electrical connector. The heater can include either one coil to provide radiated thermal output in a 180° range or two coils to provide radiated heat in a 360° range. The heater is connectable to a base coupled to an electrical source to energize the heater. The method of manufacturing enables the heater to be produced with either one coil or two coils, thereby providing a manufacturing process that can produce heaters having various capabilities.

### CROSS-REFERENCE TO RELATED APPLICATIONS

This application claims the benefit of U.S. Provisional Patent Application No. 60/602,204, filed Aug. 17, 2004.

### FIELD OF THE INVENTION

This invention relates to heating elements and, more particularly, to ceramic, infrared-radiant heaters.

### BACKGROUND OF THE INVENTION

Heat transfer may be accomplished through convection, conduction and radiation. As is known, convection is heat transfer by mass motion of a medium such as air or water when the heated medium is caused to move away from the source of heat, carrying energy with it; conduction is heat transfer by means of molecular agitation within a material without any motion of the material as a whole; and radiation is heat transfer by the emission of electromagnetic waves that carry energy away from the emitting object. Of the foregoing, radiation is the most efficient and flexible heat transfer means that is adaptable to a variety of applications.

Radiant heating elements are typically used in applications where directional or focused heating is required. To this end, as is known, quartz heaters include elongated tubes and metal reflectors, and ceramic heaters are formed as curved or flat panels. Some processes used to manufacture heaters limit the shapes that the heaters can assume. Other processes have been developed to produce heaters having shapes that other processes cannot duplicate; however, such processes have limitations on the internal construction of such heaters. These limitations on internal construction do not provide a heater having the highest potential efficiency. Yet other processes only allow for the production of a single type of heater (i.e., the process is capable of only producing a heater that radiates in a 180° range or a heater that radiates in a 360° range, not both).

### BRIEF SUMMARY OF THE INVENTION

In view of the drawbacks in the heater art, there is a need for a heater that can be formed in desirable shape and have desirable internal construction to increase efficiency of the heater. Accordingly, a process is also desired that can produce such an efficient heater. There is also a need for a process that can produce heaters have various thermal output capabilities. For example, a process is desired that can produce a heater that radiates thermal output at 180° or produce a heater that radiates thermal output at 360°.

In some aspects, the invention provides a heater including a ceramic cylindrical body, an electrical connector connected to the body and adapted to be coupled to an electrical source to energize the heater, and a coil embedded in the body and electrically coupled to the electrical connector for producing thermal output.

In other aspects, the invention provides a heater including a cylindrical body including a first end and a second end, an electrical connector connected to the body and adapted to be coupled to an electrical source to energize the heater, and a coil electrically coupled to the electrical connector and operable to produce thermal output. The coil is embedded within the body and includes portions that zigzag toward and away from the first and second ends of the body. The portions of the coil being substantially equidistantly spaced from one another around the body.

In yet other aspects, the invention provides a heater including a body, an electrical connector connected to the body and adapted to be coupled to an electrical source to energize the heater, a coil electrically coupled to the electrical connector for producing thermal output, and a reflector connected to the body for reflecting thermal output away from the electrical connector.

In further aspects, the invention provides a method of manufacturing a ceramic heater, the method including providing a mold, introducing a viscous ceramic material into the mold, introducing a coil into the ceramic material after introducing the ceramic material into the mold, allowing the ceramic material to harden in the mold to embed the coil in the ceramic material, and removing the hardened ceramic material and coil from the mold.

In yet further aspects, the invention provides a method of manufacturing a ceramic heater, the method including providing a mold, introducing a viscous ceramic material into the mold, performing one of two of the following steps: introducing a single coil into the ceramic material after introducing the ceramic material into the mold or introducing two coils into the ceramic material after introducing the ceramic material into the mold. The method also includes allowing the ceramic material to harden in the mold to embed the coil or coils in the ceramic material, and removing the hardened ceramic material and the coil or coils from the mold.

### BRIEF DESCRIPTION OF THE DRAWINGS

FIG. 1 shows a perspective view of an exemplary ceramic infrared radiant heater;

FIG. 2 shows an elevation view of the heater of FIG. 1;

FIG. 3 shows a cross-section view of the heater taken along line 3-3 in FIG. 2;

FIG. 4 shows an exemplary base for energizing the heater of FIGS. 1 and 2;

FIG. 5 shows an elevation view of two exemplary heaters;

FIG. 6 shows a perspective view of the heater of FIGS. 1-3 with a reflector;

FIG. 7 shows a front perspective view of the reflector of FIG. 6;

FIG. 8 shows a rear plan view of the reflector of FIGS. 6 and 7;

FIG. 9 shows an exemplary heater and reflector combination coupled to an exemplary base;

FIG. 10 shows an exemplary heater and reflector combination coupled to an exemplary electrical box;

FIG. 11 shows an exemplary heater coupled to an exemplary electrical box with a guard;

FIG. 12A shows a perspective view of the heater with an exemplary heat sensor; and

FIG. 12B shows a cross-section similar to FIG. 3 with an exemplary heat sensor.

### DETAILED DESCRIPTION

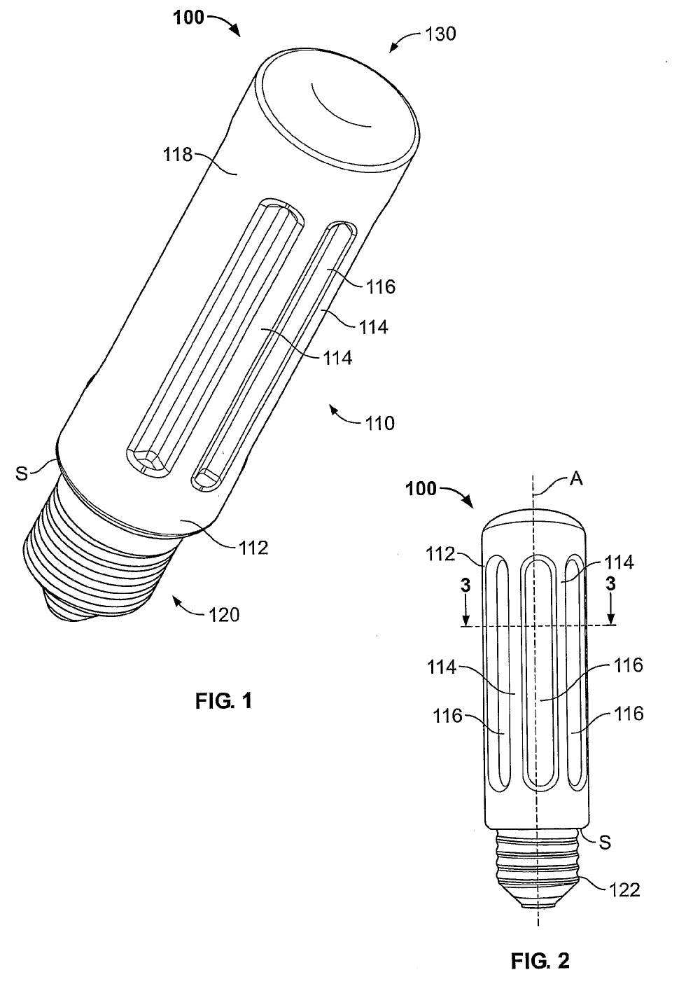

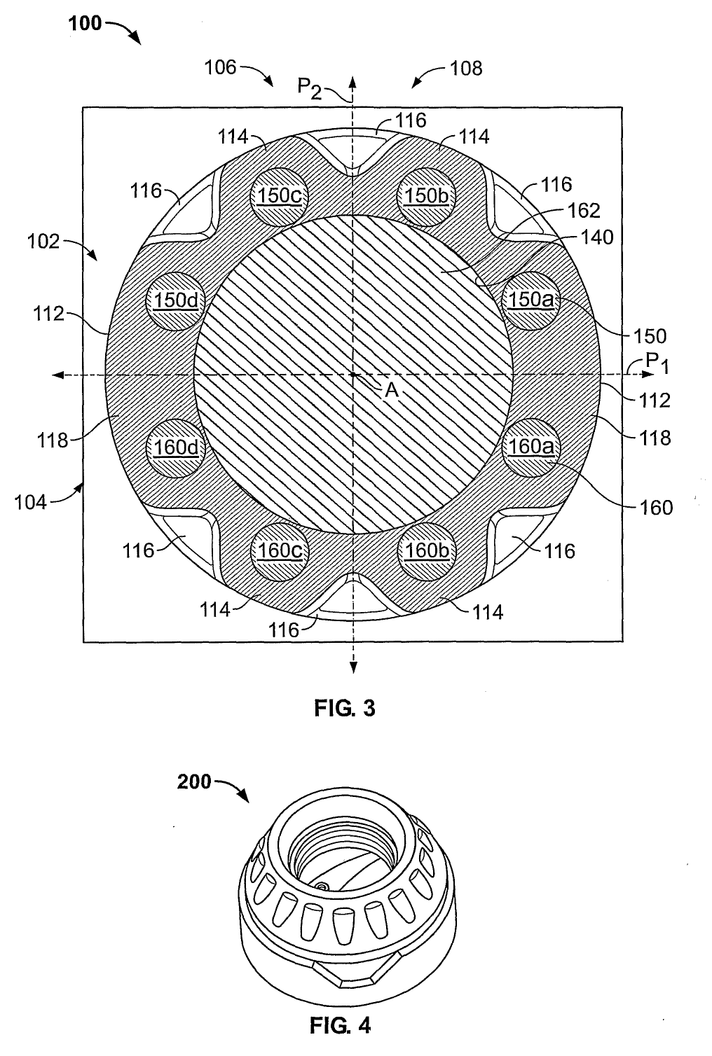

Referring now to the figures and particularly FIGS. 1-3, a ceramic heater 100 is described. As shown in FIG. 1, the ceramic heater 100 has an elongated, generally cylindrical-shaped body 110 made of a ceramic material with a first end 120 and a second end 130. A lengthwise axis A (see FIGS. 2 and 3) extends through the center of the body 110 and the first and second ends 120, 130. Referring briefly to FIG. 3, the lengthwise axis A is defined by the intersection of two planes P1 and P2. The planes P1, P2 are oriented perpendicular to each other, and each of the planes P1, P2 bisect the heater 100 into symmetrical upper and lower halves 102, 104 and symmetrical left and right halves 106, 108, respectively.

As shown in FIGS. 1 and 2, the body 110 includes an outer surface 112 having narrow ribs 114 separated by channels 116. As shown in FIGS. 1 and 2 the narrow ribs 114 traverse substantially the length of the body 110 parallel to the axis A. As can be appreciated from FIGS. 1 and 3, wide ribs 118 that are diametrically opposed also substantially traverse the length of the body 110 parallel to the axis A. As shown, each channel 116 parallels the axis A along a portion of the body 110. More particularly, each channel 116 extends from a first point proximate the first end 120 to a second point proximate the second end 130. The channel 116 may be generally U-shaped or V-shaped as shown, but the channel 116 may be shaped otherwise. Alternatively, the channel 116 can extend substantially the entire length of the body 110. As best illustrated in FIG. 2, each of the top and bottom halves 102, 104 (i.e., the halves with respect to plane P1 bisecting the wide ribs 118) includes three channels 116. Referring now to FIG. 3, the three channels 116 of each of the upper and lower halves 102, 104 are arcuately separated by approximately forty-five degrees (45°) with respect to the axis A, whereas the two channels 116 of each of the left and right halves 106, 108 (i.e., the whole channels and not the channels bisected by plane P2) are arcuately separated by approximately ninety degrees (90°) with respect to the axis A.

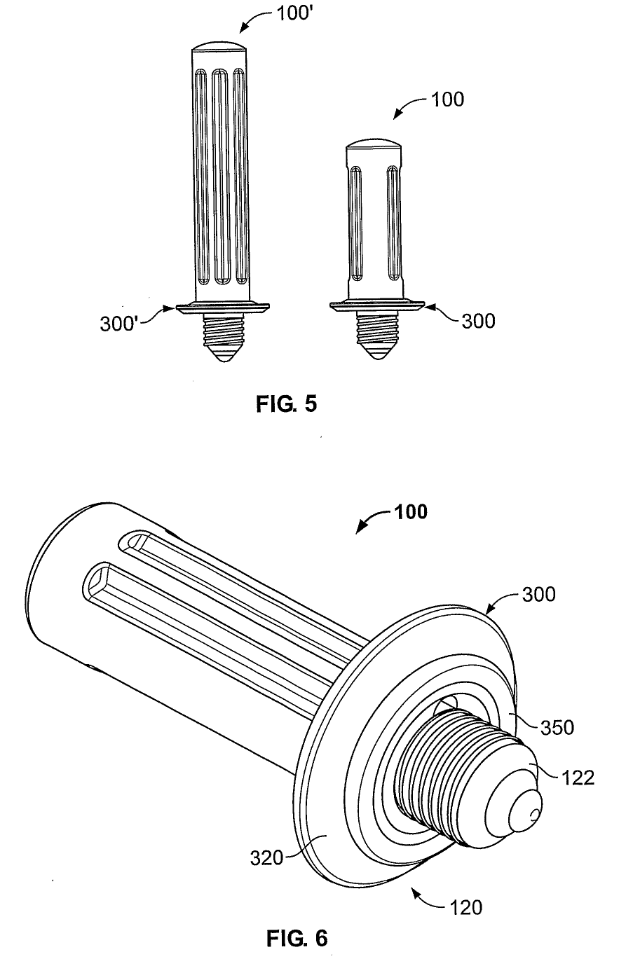

As shown in FIGS. 1 and 2, the second end 130 is slightly domed or convex, but alternatively the second end 130 may be flat, concave or shaped otherwise. The first end 120 includes an electrical connector 122 engageable with a base 200 for receiving electrical current and energizing the heater 100. As shown, the connector 122 is an Edison-type, threaded, screw-in connector for cooperating with a screw-in base known in the art such as a typical incandescent bulb fixture. Alternatively, the connector 122 may be a bayonet-style connector, one or more blades such as a polarized plug, or other connectors known in the art. One exemplary screw-in base 200 for use with the heater 100 is illustrated in FIG. 4. Alternatively, the heater 100 may be provided with wire leads that may be soldered, crimped or otherwise permanently or semi-permanently connected with an electrical source such as wiring, a switch, a breaker, a fuse or the like.

Referring now to FIG. 3, the heater 100 is shown to include one or more resistance coils, filaments, wires or the like 150, 160, which may be permanently attached to the connector 122. As shown, the heater 100 has a central recess 140 coaxial with the axis A such that the heater 100 has a generally annular cross-sectional shape. As illustrated, the recess 140 is cylindrical, but alternatively the recess may be shaped otherwise. Resistance coils 150, 160 are shown embedded within the ceramic body 110, particularly in the upper and lower halves 102, 104 respectively. As can be appreciated from FIGS. 1-3, each coil 150, 160 is arranged generally in an M-shape, W-shape, or otherwise in a zigzag-like shape traversing the lengths of the ribs 114, 118 back and forth. Although two coils 150, 160 are illustrated, fewer or additional coils may be provided. Moreover, the coils may be connected in series or parallel (or a combination thereof) to achieve a predetermined wattage (i.e., heat output) at a predetermined voltage.

One or more coils 150, 160 of the heater 100 are cast in place. The heater 100 is formed by a casting process wherein a mold is provided that is the negative image of the heater 100. In accordance with the heater 100 illustrated in FIG. 3, the mold (not shown) may be a two-part mold wherein a first part of the mold forms the upper half 102 with coil 150, and a second part of the mold forms the lower half 104 with coil 160. A ceramic slip or viscous ceramic material (i.e., viscous slurry) is poured into the mold and allowed to sit for a period time. During such period of time, the ceramic material begins to harden. The mold may be made of plaster or the like to wick the moisture from the slip thereby facilitating hardening of the ceramic material and additionally facilitating later removal of the heater 100 from the mold due to shrinkage/contraction of the heater 100 during hardening. The longer the settling time for the ceramic material, the thicker the hardened portion of the ceramic material becomes. In some constructions, the desired thickness of the hardened ceramic material is about one-eighth of an inch. After the appropriate period of time has passed and the desired thickness of the hardened ceramic material has been achieved, the remaining unhardened ceramic material is evacuated or otherwise removed from the mold, thereby leaving only the hardened ceramic material. The hardened ceramic material remains sufficiently soft to allow introduction of the coils 150, 160 into the ceramic material. The coils 150, 160 may be introduced by pressing them into the ceramic material or by any other appropriate manner. During the casting of the heater 100 or thereafter, a thermal insulator 162 may be inserted in the central recess 140 to reflect inwardly radiating heat from the coils 150, 160, thereby increasing thermal output and efficiency of the heater 100. The thermal insulator 162 may be a ceramic fiber material, fiberglass, or the like. The thermal insulator 162 can be shaped complimentary to the shape of the recess 140 such that no void is provided between the insulator 162 and the wall of the recess 140. Alternatively, the insulator can have any shape either complimentary or not to the shape of the recess 140 and still be within the spirit and scope of the invention.

The above described process is used to produce a heater 100 having two coils 150, 160 for radiating thermal output 360° from the heater 100. Alternatively, the above process can be used to produce a heater 100 having only a single coil 150 or 160 for radiating thermal output 180° from the heater 100. The process differs slightly from that described above when producing a 180° radiating heater. Particularly, only one of the coils 150 or 160 is introduced into the ceramic material, rather than two coils. Upon completion of such a manufacturing process, a heater 100 is provided that radiates thermal output in a 180° range.

As another alternative process for producing the heater 100, the coils 150, 160 are disposed in the mold prior to introduction of viscous ceramic material into the mold. After placement of the coils into the mold, viscous ceramic material is poured into the mold over the coils and allowed to harden. Other aspects of this process are similar to the previously discussed processes and therefore will not be discussed again.

After removing the hardened heater 100 from the mold, the heater 100 may be painted, coated or otherwise finished. As known in the art, the heater 100 may be finished by applying a glaze and firing the heater 100 in a kiln to achieve a final hardness of the ceramic material and vitrify the glaze to provide a durable coating. Further, the glaze or coating may change colors according to the temperature of the heater 100. For example, the heater 100 may be a first color when un-energized and cool, and a second color when energized and hot. Thus, the coating may provide a visual indication of whether or not the heater 100 is safe to handle or approach, thereby reducing accidental burns. After finishing the heater 100, the connector 122 is attached to the first end 120 and the coils 150, 160 are coupled to the connector 122. Thus, as known in the art, when the coils 150, 160 are energized, the coils 150, 160 provide resistance heating to the surrounding ceramic material of the body 110 so that the heater 100 radiates infrared energy.

As mentioned above, each of the coils 150, 160 substantially zigzags back and forth along the length of the ceramic body 110 making four lengths 150a-d, 160a-d. As shown in FIG. 3, adjacent lengths of each coil 150, 160 are arcuately separated by approximately forty-five degrees so that the lengths 150a-d, 160a-d are equally spaced about three hundred sixty degrees of the heater's annular cross-section. In view of the foregoing one will appreciate that the heater 100 provides omnidirectional thermal heat output analogous to a whip antenna providing omnidirectional signal transmission therefrom. That is, infrared energy radiates from the body 110 about 360° with respect to the axis A.

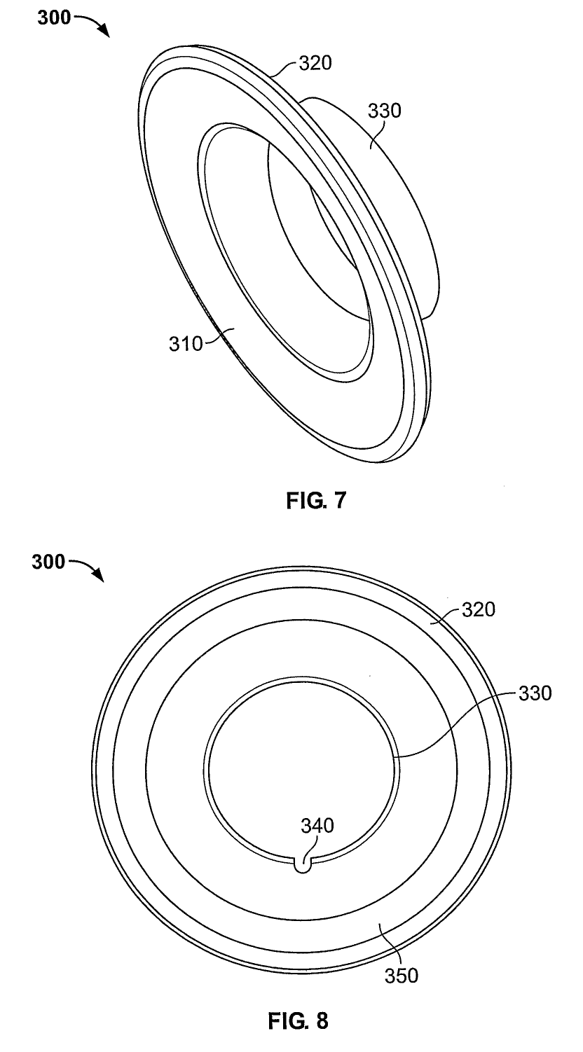

As shown in FIG. 5, the heater 100 is not limited to a particular length or diameter. For example, heater 100′ is longer than heater 100 to provide additional volume and surface area to achieve greater watt densities (i.e., thermal output). Moreover, the heater 100 may operate at various predetermined input levels (e.g., 120V, 240V) and output levels (e.g., 50 W, 100 W, 150 W, etc.) in accordance with the physical characteristics (e.g., length, diameter) and wiring of the coils 150, 160. Additionally, the generally annular cross-sectional shape of the heater 100 mentioned previously facilitates fast heating and cooling rates.

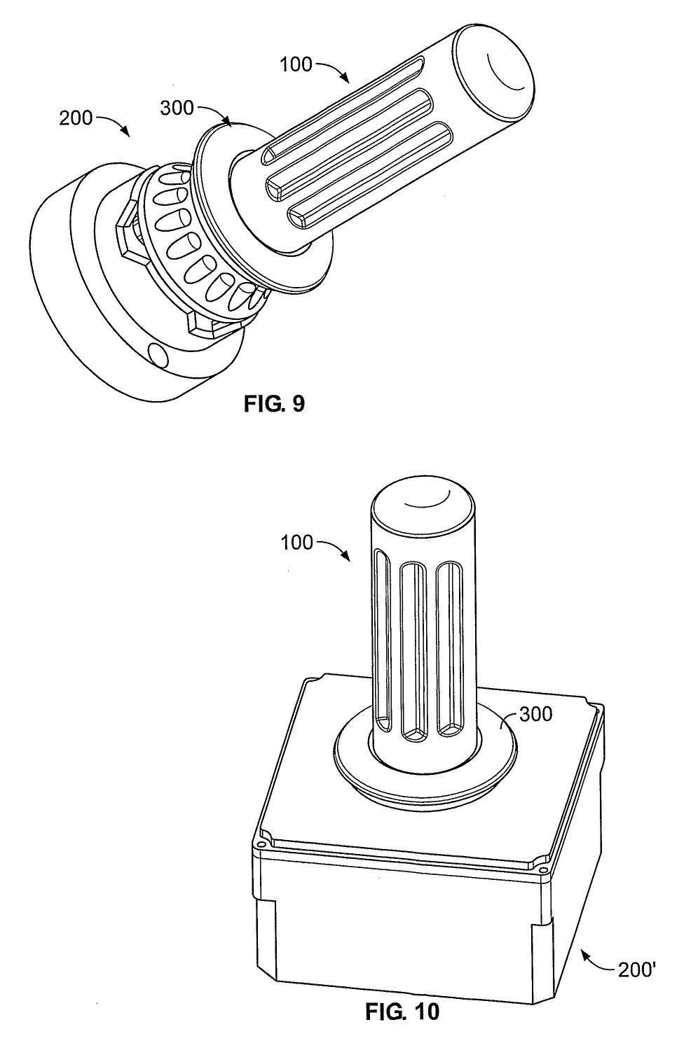

To further the efficiency and safety of the heater 100, a reflector 300 may be provided as illustrated in FIG. 6. The reflector 300 directs radiant heat emitted by the heater 100 away from the first end 120, and more particularly away from the connector 122 and energizing source to inhibit overheating thereof. The reflector 300 may be removably or permanently coupled to the heater 100. Referring now to FIGS. 7 and 8, the reflector 300 is illustrated to be generally annular in shape to mate with the first end 120. The central hole of the reflector 300 is sized and shaped to fit over the connector 122, but the diameter of the central hole is not sufficient to permit the reflector 300 to advance further than the shoulder S (FIGS. 1 and 2) onto the body 110. As shown in FIG. 7, the front surface 310 is generally concave to direct emitted heat away from the first end 120. The front surface 310 may be flat and additionally may include a ring member 330 for facilitating frictional coupling of the reflector 300 to the heater 100, thereby inhibiting accidental disengagement of the reflector 300 from the heater 100.

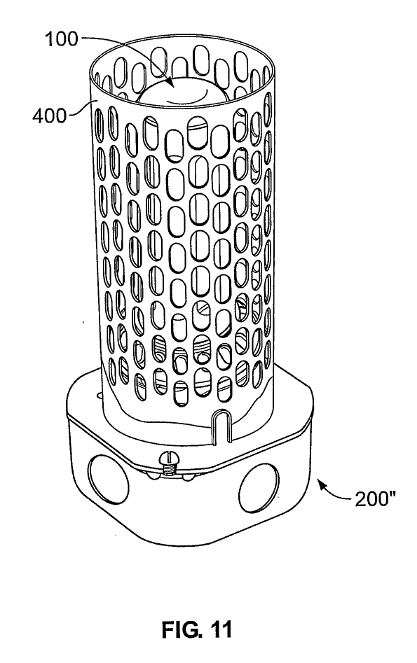

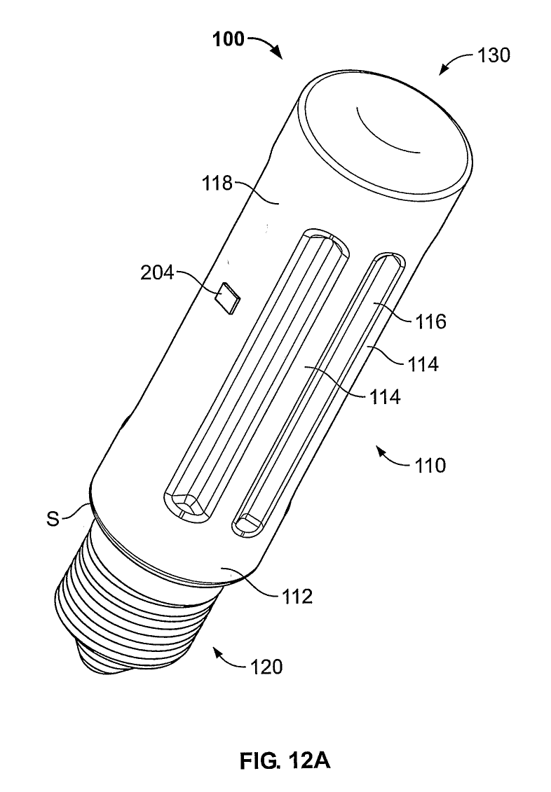

As shown in FIG. 8, the central hole may include a notch 340 that cooperates with the connector 122. As mentioned previously, the coils 150, 160 are coupled to the connector 122, such as by soldering. Therefore, the notch 340 may be sized and shaped to fit about the soldered connection to provide for a proper fit of the reflector 300 to the heater 100. Moreover, the notch 340 may provide a means to lockably engage the reflector 300 to the heater 100 such as with a friction or interference fit. As best illustrated in FIGS. 6 and 8, the rear surface 320 may include a sealing member 350 such as an o-ring, washer, grommet or the like. The sealing member 350 may be made of a flexible material such as rubber so that the reflector 300 may sealably couple with an energizing source (e.g., base 200 of FIGS. 4 and 9, or electrical box 200′, 200″ of FIGS. 10 and 11). Thus, the heater 100 may be employed in applications wherein it is desirable to inhibit intrusion of the ambient environment (e.g., dust, humidity, precipitation, etc.) into the source. Moreover, the heater 100 in combination with the reflector 300 may be employed safely and reliably in acidic or caustic environments/processes wherein the sealing member 350 cooperates with an enclosure or the like to protect the connector 122 and the source's electrical contacts.

Referring now to FIGS. 9-11, the combination heater 100 and reflector 300 is illustrated as engaged with various energizing bases 200, 200′, 200″. For example, as shown in FIG. 9, a screw-in base 200 (see also FIG. 4) may energize heater 100 and be sealed by the reflector 300. In another example illustrated in FIG. 10, the reflector 300 cooperates with base 200′, which is a sealed NEMA-7 rated box or the like, to provide an environmentally sealed enclosure for energizing the heater 100. In yet another example illustrated in FIG. 11, the base 200″ may include a guard 400 such as a mesh or perforated enclosure to inhibit direct contact with the heater 100. The heater 100 may be used with or without the reflector for providing omnidirectional radiant infrared heating in various commercial, industrial or residential applications including, but not limited to: space heating; process heating such as plastic thermoforming; food service; pet care and incubation; preventing moisture or condensation in electrical control boxes and telecommunications enclosures; and resistor/load banks. Moreover, two or more heaters 100 may be arranged in a housing or the like to provide a heater array.

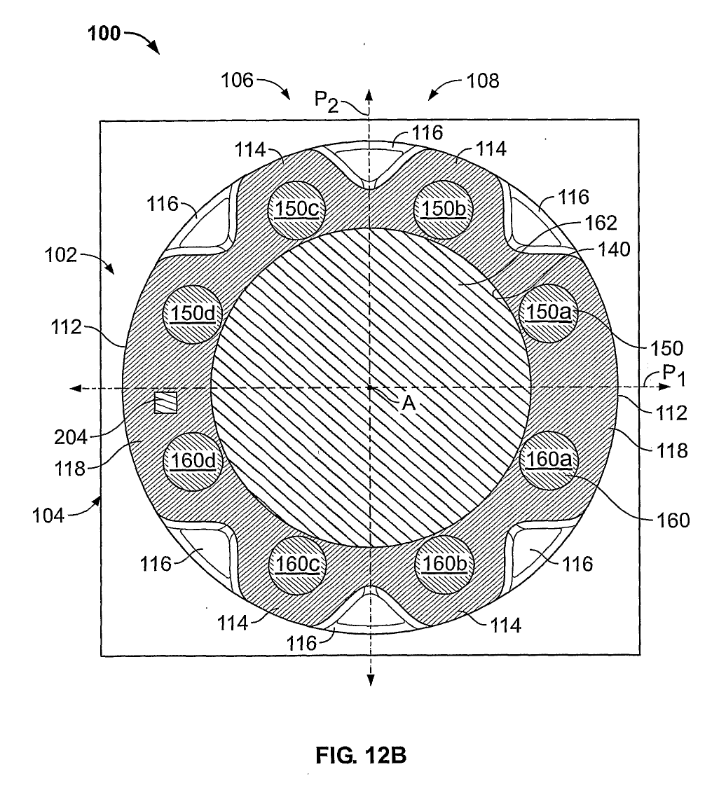

Exemplary embodiments of this invention are described herein. Variations of those embodiments may become apparent to those of ordinary skill in the art upon reading the foregoing description. For example, although the heater 100 is generally cylindrical in shape, a portion of the body 110 may extend radially inward or outward with respect to the lengthwise axis A. In a particular example, the second end 130 may extend or balloon away from the axis A to provide a bulb-like shape (i.e., incandescent Edison bulb shaped). Also for example, with reference to FIGS. 12A and 12B, the heater 100 may include a temperature sensor 204 such as a thermocouple or the like to provide an indication, signal or the like relative to the heater's output so that the heater 100 output may be varied or otherwise controlled such as in a dynamic, feedback-controlled temperature control system. The temperature sensor 204 can be mounted externally of the body 110 (see FIG. 12A) or embedded within the body 110 (see FIG. 12B). The inventors expect skilled artisans to employ such variations as appropriate, and the inventors intend for the invention to be practiced otherwise than as specifically described herein. Accordingly, this invention includes all modifications and equivalents of the subject matter recited herein and in the claims appended hereto as permitted by applicable law. Moreover, any combination of the above-described elements in all possible variations thereof is encompassed by the invention unless otherwise indicated herein or otherwise clearly contradicted by context.

1. A heater comprising:
a ceramic cylindrical body;
an electrical connector connected to the body and adapted to be coupled to an electrical source to energize the heater; and
a coil embedded in the body and electrically coupled to the electrical connector for producing thermal output.

2. The heater of claim 1, wherein the body has a longitudinal axis extending through a center thereof, and wherein the heater provides an omnidirectional thermal output with respect to the longitudinal axis.

3. The heater of claim 1, wherein the electrical connector is connected to an end of the ceramic cylindrical body.

4. The heater of claim 1, wherein the electrical connector is a screw-in electrical connector.

5. The heater of claim 1, wherein the ceramic cylindrical body has a longitudinal axis extending through a center thereof, and wherein the coil has a first portion that traverses the body upwardly substantially parallel to the longitudinal axis and a second portion that traverses the body downwardly substantially parallel to the longitudinal axis, the first and second portions being substantially parallel to each other.

6. The heater of claim 5, wherein the first portion and the second portion of the coil are arcuately spaced from one another by about 45 degrees relative to the longitudinal axis.

7. The heater of claim 1, wherein the coil generally forms an “M” shape or a “W” shape within the body.

8. The heater of claim 1, wherein the ceramic cylindrical body has a longitudinal axis extending through a center thereof, and wherein the body defines a plurality of channels and a plurality of ribs in an outer surface of the body, the ribs being positioned between the channels, the channels and the ribs extending substantially parallel to the longitudinal axis.

9. The heater of claim 8, wherein the coil is embedded in the body within the plurality of ribs.

10. The heater of claim 8, wherein the channels are arcuately separated from one another by about forty-five degrees relative to the longitudinal axis.

11. The heater of claim 8, wherein the channels are arcuately separated from one another by about ninety degrees relative to the longitudinal axis.

12. The heater of claim 8, wherein the plurality of channels includes a first set of channels and a second set of channels, the channels within the same set of channels being arcuately separated from each other by about forty-five degrees relative to the longitudinal axis, and wherein one of the channels of the first set of channels is arcuately separated from one of the channels of the second set of channels by about ninety degrees relative to the longitudinal axis.

13. The heater of claim 1, wherein the coil is a first coil, the heater further comprising a second coil embedded in the body and electrically coupled to the electrical connector for producing thermal output.

14. The heater of claim 13, wherein the first and second coils have portions equidistantly spaced from one another around the body to provide omnidirectional thermal output.

15. The heater of claim 1, further comprising a reflector connected to the body for reflecting thermal output away from the electrical connector.

16. The heater of claim 15, wherein the reflector is annularly shaped and has a central opening therethrough, the body being alignable with the central opening of the reflector and the reflector being slidable over the body.

17. The heater of claim 15, wherein the electrical connector is connected to the body at an end of the body, the reflector being connected to the body adjacent the electrical connector.

18. The heater of claim 15, wherein the reflector is annularly shaped and has a concave surface.

19. The heater of claim 1, wherein the body includes a coating, the coating having a first color when the body is cool and a second color when the body is hot, the first and second colors being different.

20. The heater of claim 1, wherein the body has a central recess and a longitudinal axis extending through a center of the body and through the central recess, the heater further comprising a thermal insulator positioned within the central recess.

21. A heater comprising:
a cylindrical body including a first end and a second end;
an electrical connector connected to the body and adapted to be coupled to an electrical source to energize the heater; and
a coil electrically coupled to the electrical connector and operable to produce thermal output, the coil being embedded within the body and including portions that zigzag toward and away from the first and second ends of the body, the portions of the coil being substantially equidistantly spaced from one another around the body.

22. The heater of claim 21, wherein the coil generally forms an “M” shape or a “W” shape within the body.

23. The heater of claim 21, wherein the body has a longitudinal axis extending through a center thereof, and wherein the body has a plurality of channels and a plurality of ribs in an outer surface of the body, the ribs being positioned between the channels, the channels and the ribs extending substantially parallel to the longitudinal axis.

24. The heater of claim 23, wherein the portions of the coil are embedded in the body within the plurality of ribs.

25. The heater of claim 21, wherein the coil is a first coil, the heater further comprising a second coil electrically coupled to the electrical connector and operable to produce thermal output, the second coil being embedded within the body and including portions that zigzag toward and away from the first and second ends of the body, the portions of the second coil being equidistantly spaced from one another around the body, and wherein one of the portions of the first coil being equidistantly spaced from one of the portions of the second coil.

26. The heater of claim 25, wherein the body has a longitudinal axis extending through a center thereof, and wherein the body defines a plurality of channels and a plurality of ribs in an outer surface of the body, the ribs being positioned between the channels, the channels and the ribs extending substantially parallel to the longitudinal axis.

27. The heater of claim 26, wherein the portions of the first and second coils are embedded in the body within the plurality of ribs.

28. The heater of claim 21, wherein the body is made of ceramic.

29. The heater of claim 21, wherein the electrical connector is connected at one of the first end or the second end.

30. A heater comprising:
a body;
an electrical connector connected to the body and adapted to be coupled to an electrical source to energize the heater;
a coil electrically coupled to the electrical connector for producing thermal output; and
a reflector connected to the body for reflecting thermal output away from the electrical connector.

31. The heater of claim 30, wherein the reflector is connected to the body adjacent the electrical connector.

32. The heater of claim 30, wherein the reflector is annularly shaped and has a central opening therethrough, the body being alignable with the central opening of the reflector and the reflector being slidable over the body to the position where the reflector is connected to the body.

33. The heater of claim 30, wherein the reflector is annularly shaped and has a concave surface.

34. The heater of claim 30, further comprising a base electrically coupled to the electrical source, the electrical connector adapted to be connected to the base for energizing the heater.

35. The combination of claim 34, wherein the electrical connector is a screw-in electrical connector and the heater is screwed into the base.

36. The combination of claim 34, wherein the electrical connector of the heater is electrically wired to the base.

37. The combination of claim 34, further comprising a guard connected to one of the base and the heater to inhibit contact of the heater.

38. The combination of claim 37, wherein the guard is connected to the base.

39. The combination of claim 34, wherein reflector engages the base when the heater is connected to the base.

40. The combination of claim 39, wherein the reflector includes a sealing member engageable with the base to inhibit intrusion of products of ambient environment.

41. The combination of claim 40, wherein the sealing member is made of a resilient material.

42. A method of manufacturing a ceramic heater, the method comprising:
providing a mold;
introducing a viscous ceramic material into the mold;
introducing a coil into the ceramic material after introducing the ceramic material into the mold;
allowing the ceramic material to harden in the mold to embed the coil in the ceramic material; and
removing the hardened ceramic material and coil from the mold.

43. The method of claim 42, wherein providing a mold includes providing a mold with a first portion and a second portion, and wherein introducing a viscous ceramic material includes introducing a viscous ceramic material into both the first and second portions of the mold, and wherein introducing a coil into the ceramic material includes introducing a first coil in the ceramic material of the first portion of the mold and introducing a second coil in the ceramic material of the second portion of the mold.

44. The method of claim 42, further comprising positioning a thermal insulator into the mold and wherein pouring further includes pouring the ceramic viscous material into the mold around the thermal insulator.

45. The method of claim 44, wherein the thermal insulator is embedded within the ceramic material when the ceramic material is hardened.

46. The method of claim 42, wherein the mold is shaped to form a substantially cylindrical body of the heater.

47. A method of manufacturing a ceramic heater, the method comprising:
providing a mold;
introducing a viscous ceramic material into the mold;
performing one of two of the following steps,
introducing a single coil into the ceramic material after introducing the ceramic material into the mold;
introducing two coils into the ceramic material after introducing the ceramic material into the mold;
allowing the ceramic material to harden in the mold to embed the coil or coils in the ceramic material; and
removing the hardened ceramic material and the coil or coils from the mold.

48. The method of claim 47, wherein the heater has a longitudinal axis extending through a center thereof, and wherein introducing a single coil into the ceramic material provides a heater adapted to radiate heat at about 180° relative to the longitudinal axis.

49. The method of claim 47, wherein the heater has a longitudinal axis extending through a center thereof, and wherein introducing two coils into the ceramic material provides a heater adapted to radiate heat at about 360° relative to the longitudinal axis.

50. The method of claim 47, wherein providing a mold includes providing a mold with a first portion and a second portion, and wherein introducing a viscous ceramic material includes introducing a viscous ceramic material into both the first and second portions of the mold, and wherein introducing a single coil into the ceramic material includes introducing a single coil into one of the first and second portions of the mold, and wherein introducing two coils into the ceramic material includes introducing one of the coils into the first portion of the mold and introducing the second coil into the second portion of the mold.

51. The method of claim 47, wherein the mold is shaped to form a substantially cylindrical body of the heater.
